(19) United States
(12) Patent Application Publication
(10) Pub. No.: US 2006/0155719 A1
(43) Pub. Date: Jul. 13, 2006

(54) Complex event discovery in event databases

(75) Inventors: Joris Mihaeli, Herzeliya (IL); David Botzer, Haifa (IL); Opher Etzion, Haifa (IL); Ziva Sommer, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/032,579

(22) Filed: Jan. 10, 2005

(51) Int. Cl. G06F 7/00

(52) U.S. Cl. 707/100

(57) ABSTRACT

Situation detection systems and methods are provided, in which the capabilities of standard event stores and relational systems are enhanced by augmented event-oriented algebraic operators. Rules involving the event-oriented operators are combined with conventional relational algebraic techniques, and applied to an event database in order to detect more complex patterns, indicative of composite events or situations.

### BACKGROUND OF THE INVENTION

1. Field of the Invention

This invention relates to computer software and systems. More particularly, this invention relates to tools and methods for detecting complex events and conditions in a computer system.

2. Description of the Related Art

Data relating to events occurring in particular application areas can be stored in specialized repositories in order to provide a basis for more thorough and complex interpretation and correlation of the events. Consequently, it has been proposed to perform off-line querying over the event history and to detect patterns leading to the discovery of complex events.

There are several products and projects that support event stores, e.g., the Tivoli® Enterprise Console, and the Common Event Infrastructure, both produced by International Business Machines Corp. (IBM), New Orchard Road, Armonk, N.Y. Event repositories may use database management systems (DBMS), which can be relational or object-oriented systems. Alternatively, event repositories can be dedicated storage facilities. The data management systems use standard languages, e.g., structured query language (SQL), object query language (OQL). Active mechanisms in the above-noted products detect and react to updates in the database that could affect data integrity, or may execute some application logic.

However, the query capabilities of these languages are rather general, treating the event data as standard relational or object-oriented data, and are insufficient to adequately detect complex events.

### SUMMARY OF THE INVENTION

According to a disclosed embodiment of the invention, complex event detection systems and methods are provided, in which the capabilities of standard event stores and relational systems are enhanced by augmented event-oriented algebraic operators. Rules involving the event-oriented operators are combined with conventional relational algebraic techniques, and applied to an event database in order to detect more complex patterns, indicative of composite events or situations.

In addition to searching for particular situations, some embodiments of the invention employ selection of event instances that comprise such situations, and the use of event consumption policies. These techniques facilitate focused situation detection. The techniques disclosed herein are suitable for off-line detection and processing of complex events.

An event query processor is realized, using event-oriented algebraic operators together with conventional algebraic operators in an event query language. The event query processor accepts event rule definitions as input. A general event database structure is defined in order to facilitate event detection algorithms. The event query processor has a layered information architecture suitable for implementing the constructs of the event query language. In one embodiment, an event detection strategy is based on interval relationships among situation lifespans.

An event processing system is disclosed in U.S. Pat. No. 6,604,093, of common assignee herewith, and herein incorporated by reference. This arrangement is limited to real-time or on-line event processing, which requires a different architecture and employment of algorithms than are used in the instant invention.

The invention provides a method for situation detection implemented by a computer, which is carried out by storing component events in an event database, specifying a composite event as a combination of at least first and second instances of the component events, and defining a rule, which causes a reaction to be invoked upon detection of the composite event in the event database, wherein the rule includes at least one algebraic event-oriented operator. The method is further carried out by defining a query for the component events that includes the rule, executing the query to search the event database, and applying the rule in the event database in order to determine whether the first and second instances of the component events can satisfy the rule. The method is further carried out by, responsively to applying the rule, determining that the composite event has occurred, and invoking the reaction.

According to one aspect of the method, the rule includes a specification of a lifespan of at least one of the component events.

In another aspect of the method, the set of rules refer to a plurality of lifespans, and the method is further carried out by ordering the lifespans in accordance with a predetermined sorting criterion, defining a lifespan graph having in which the nodes are the lifespans and the edges are interval relationships among the lifespans. The order between the lifespans determines the order for execution of the rules. The method is further carried out by defining at least one new query, and executing the query and the new query in an execution order that is determined by an execution path formed by a traversal of the graph.

According to still another aspect of the method, the sorting criterion is the starting points of the lifespans.

According to an additional aspect of the method, the sorting criterion is the ending points of the lifespans.

According to one aspect of the method, applying the rule includes implementing an event consumption policy.

According to another aspect of the method, the reaction includes modifying the event database.

According to a further aspect of the method, at least one of the component events is a primitive event.

According to yet another aspect of the method, at least one of the component events is a constituent composite event.

The invention provides a computer software product, including a computer-readable medium in which computer program instructions are stored, which instructions, when read by a computer, cause the computer to perform an automated method for situation detection, which is carried out by storing component events in an event database, specifying a composite event as a combination of at least first and second instances of the component events, and defining a rule, which causes a reaction to be invoked upon detection of the composite event in the event database, wherein the rule includes at least one algebraic event-oriented operator. The method is further carried out by defining a query for the component events that includes the rule, executing the query to search the event database, and applying the rule in the event database in order to determine whether the first and second instances of the component events can satisfy the rule. The method is further carried out, responsively to applying the rule, by determining that the composite event has occurred, and invoking the reaction.

The invention provides a data processing system for situation detection, including a processor operative for storing component events in an event database, an event query processor executing in the processor that is operative to perform the steps of specifying a composite event as a combination of at least first and second instances of the component events, and accepting as an input a rule, which causes a reaction to be invoked upon detection of the composite event in the event database, wherein the rule includes at least one algebraic event-oriented operator. The method is further carried out by constructing a query including the rule for the component events, and executing the query to search the event database and applying the rule in the event database to determine whether the first and second instances of the component events can satisfy the rule. The method is further carried out, responsively to applying the rule, by determining that the composite event has occurred. The processor is operative for invoking the reaction.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a schematic a system for detection and analysis of complex events, which is constructed and operative in accordance with a disclosed embodiment of the invention;

FIG. 2 is a block diagram illustrating aspects of an event type in accordance with a disclosed embodiment of the invention;

FIG. 3 is a diagram illustrating a hierarchical relationship of event types in accordance with a disclosed embodiment of the invention; and

FIG. 4 is a block diagram presenting layered information architecture of an event query processor in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

System Overview.

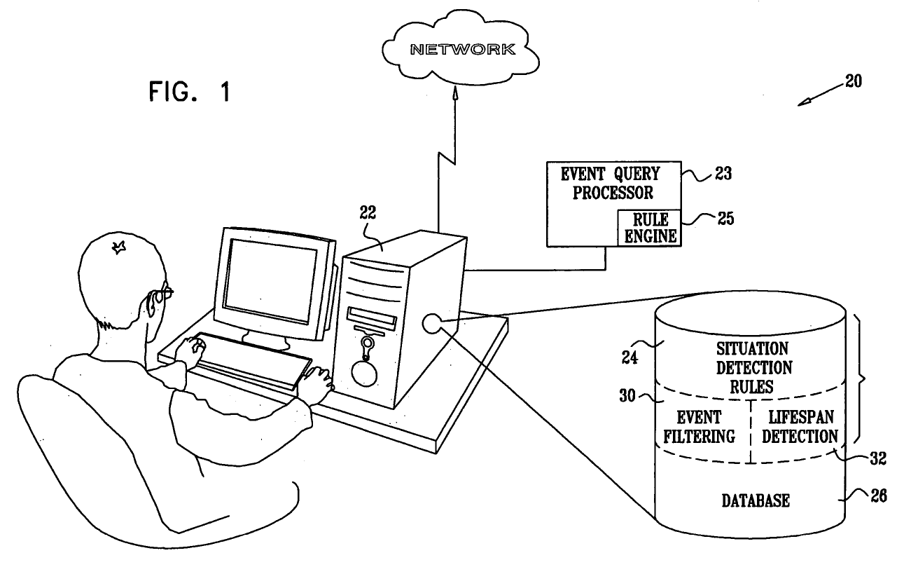

Turning now to the drawings, reference is initially made to FIG. 1, which is a schematic illustration of a system 20 for detection and analysis of complex events, which is constructed and operative in accordance with a disclosed embodiment of the invention.

The system comprises a processor 22, typically a general-purpose computer programmed with suitable software, and a memory 24. Although the memory 24 is shown in FIG. 1 as a local data store of the computer, the memory may also be maintained at a site remote from the computer, for example, on a server or shared disk system, and accessed by the processor 22 via a network. The memory 24 stores event detection rules 28, according to which the processor 22 is programmed to detect and react to situations, i.e., to specified combinations of events and conditions, using an event query processor 23, which is typically realized as a software program. The event query processor 23 can be incorporated in the Amit system, available from IBM Research Headquarters, P.O. Box 218, Yorktown Heights, N.Y. 10598. An event rule engine 25 is used by the event query processor 23 to process queries. The invention is sometimes disclosed herein with reference to Amit. However, this is exemplary, and the invention can be practiced using other event processing systems, for which suitable modifications will occur to those skilled in the art.

Situations may be detected in an event database 26, which leads to insertion of new events in the event database. Complex events that include such new events can then occur and may be detected as new situations by an off-line search of the event database 26. The rules 28 are defined by a user of the processor 22 using rule definition operators associated with the system 20. In addition, event filtering operators 30 and lifespan detection operators 32 are used.

The event database 26 contains the event data in multiple relations, one of which also has a timestamp column reflecting the temporal dimension of the events. The facilities of a standard relational DBMS allow the specification and execution of general ad-hoc queries over the event data. However, more specific queries, including a search for specific patterns and combinations of events, are difficult to achieve. This is due to the fact that the event data has to be processed in sequence, while SQL-like languages such as SQL-92 are set-oriented. In addition, the event data has certain temporal aspects that are supported neither by standard SQL, nor by known current commercial DBMS products.

Events.

In general, an event is some activity or occurrence of interest, and is represented in a data structure known as an event type. As used herein, the terms “event” and “event instance” are synonymous.

Events are basic underlying entities that are treated by the event query processor 23, and are external to the system 20. They occur in particular application areas.

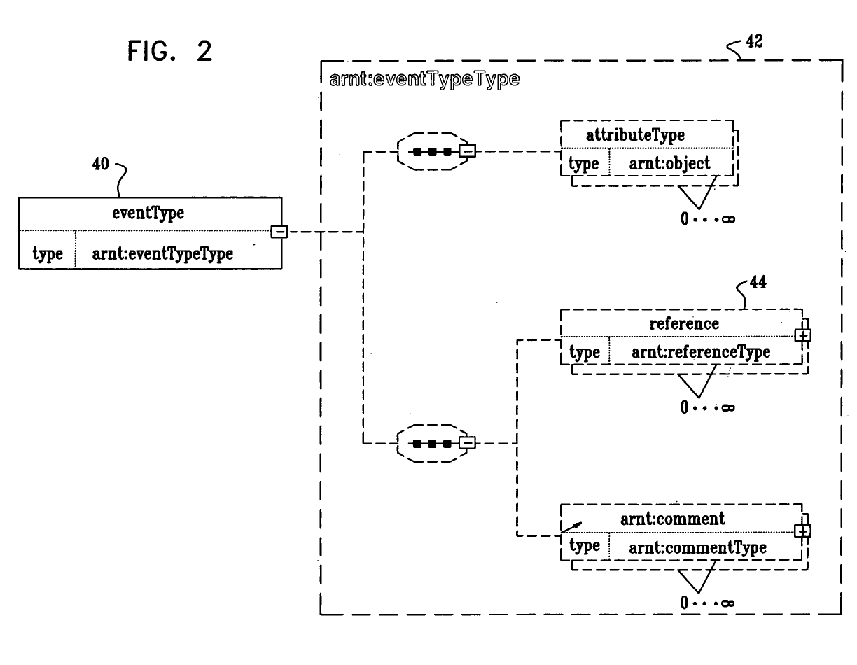

Reference is now made to FIG. 2, which is a block diagram illustrating aspects of an event type 40 in accordance with a disclosed embodiment of the invention. Each event instance 42 belongs to an event type. A reference element 44 points to a set, possibly empty, of other event types that relate to the particular event type.

An event type has some similarity to an object type, encapsulating a number of attributes. The attributes of a particular event (or an event type) uniquely identify the activity of interest. Particular event types are typically specializations of more general event types. All the event types inherit from a base event class. The base event type consists of base attributes, e.g., a point in time at which the event occurs, or is observed, a unique event identifier, an event type name, and the event source's identity.

Events can be primitive or composite. A primitive event is instantaneous and atomic. It cannot be further decomposed and it either happens or doesn't happen. Every primitive event occurs at a particular point in time, time being treated as an infinite number of linearly ordered discrete time points. All primitive events are considered to be ordered in time and to occur at specific points in time. They do not have duration.

Composite events, also referred to herein as situations, encapsulate primitive events or other constituent composite events. Composite events span some time interval during which its constituent events occur. Nevertheless, they can be associated with a single point in time: a composite event is considered to occur when the last primitive or composite event that defines it takes place. Thus, it may be assumed that composite events also have no duration and occur at the time point of the last event from the particular combination.

An event A can occur before an event B (A<B), while the event B happens after the event A, (B>A). The two events A, B may be composite, primitive, or any combination thereof.

Composite events can be detected during time intervals that include their time of occurrence as defined above. Thus, there is a distinction between the actual occurrence of a composite event, and a time interval during which it occurs. It is possible to reason about the time interval, and to relate it to other time intervals. For example, an event A can occur within a time interval I or outside of the time interval I.

Interval algebra is employed in order to reason about different time intervals. Interval algebra was proposed in the document Allen, J.: Maintaining Knowledge about Temporal Intervals, Comm. ACM, Vol. 26, No. 11, November 1983, pp. 832-843, which is herein incorporated by reference. This work introduced taxonomy of relations between temporal intervals that is complete for time intervals over a linear set of time points. According to a taxonomy between two intervals I, J, there are 13 possible relationships. Seven of these are shown in Table 1.

TABLE 1

| | |
|---|---|
| I precedes J | I happens before J and there Is non-empty |
| | interval separating them |
| I meets J | I happens before J, but there is no non-empty |
| | interval between them |
| I starts J | I has the same starting point as J, but ends |
| | earlier than J |
| I overlaps J | I starts before J, and J ends after I |
| I equals J | I and J start and end simultaneously |
| I finishes J | I starts after J, but has the same end point |
| I during J | I starts after J, and finishes before J |

Six additional relationships are the inverse relationships of the relationships shown in Table 1, except for the “equals” relationship, which is symmetric. The 13 interval relationships are mutually exclusive.

An event database stores event instance tuples that contain data relating to activities of interest in a particular application area. The events have a flat structure, and have a unique name and other attributes that can be predetermined or user-defined. The event tuples may reflect several temporal dimensions, e.g., occurrence time, detection time, and/or transaction time (the point in time when the event data is stored in the database). Detection time may not reflect the actual order of occurrence of the events as they may be received in a different order, or because the events occur in distributed environments, and their respective sensors are not synchronized. On the other hand, the transaction time sequence of events is linearly ordered, because the events are stored one at a time.

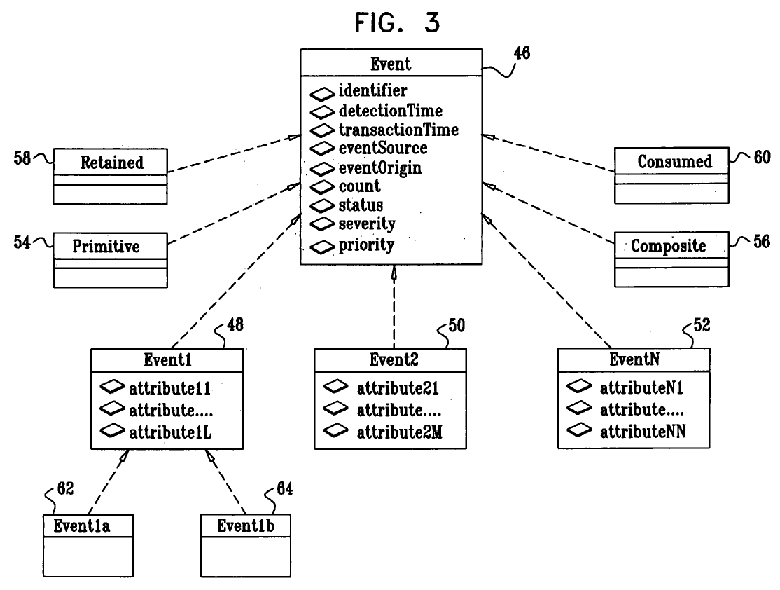

Reference is now made to FIG. 3, which is a block diagram illustrating a model hierarchical relationship of different event types in accordance with a disclosed embodiment of the invention. A root event type 46 of the hierarchy contains common event attributes, while child event types 48, 50, 52 contain specific user attributes that can be defined for a particular application area. The common attributes may include an event instance unique identifier, event detection time, and transaction time. Other common attributes may include an event source, a component where the event occurred, event status, severity code, and priority. The model illustrated in FIG. 3 defines an event type hierarchy that is specific for a particular application area, and contains additional non-overlapping specializations: primitive events 54, composite events 56, retained events 58, and consumed events 60. Additional hierarchical levels are possible, shown representatively by grandchild event types 62, 64.

Referring again to FIG. 1, in the following discussion it is assumed that base tables are defined for each of the event types, and that the root relation contains common attributes of event types, as described above with respect to FIG. 3. This approach allows limiting temporally oriented operations to the root relation, while searching for specific user attribute values via other, specialized relations. In addition to the base tables, relational views are defined for the event classes of the conceptual model. An event class combines common attributes and user attributes. These relational views facilitate the use of general event detection algorithms, and the implementation of event specification language constructs that are independent of a physical database structure.

Keys.

A key enables particular event instances to be related and facilitates the formation of event groups according to application specific criteria. Each key has a unique name. A key value can be an attribute or an expression involving specific event attribute values. The latter case is termed a “keyExpression”. A keyExpression, which may be a calculated expression, enables the specification of the data type of common event attributes. Keys can be defined for lifespans and for situations, both of which are explained hereinbelow.

Lifespans.

Lifespans correspond to time intervals in which events occur. Lifespans can be defined using database views that are referenced while executing situation queries. Views are used in conjunction with virtual tables that contain relevant subsets of the event instances. These subsets can change dynamically with the detection of new composite events. Thus, a lifespan construct is used to define intervals, which may correspond to sequences of events, during which specific situations are valid and might be detected.

A lifespan has one or more initiators, zero or more terminators, and may have related keys. A lifespan initiator specifies that a situation, which is valid for that life-span, may be initiated at the beginning of an event history, that is when a startup event occurs, or with the occurrence of a given event type. A lifespan initiator may also define selection conditions for the event instances. In order to define a lifespan it is necessary to determine starting and terminating time points, and a set of relevant event instances. Typically, a parameter transactionTime, which indicates the transaction time of an event, as described hereinabove, can be used as the temporal dimension. It is also possible to use a parameter detectionTime, that is, the time at which an event is detected.

A lifespan terminator can be an event instance, a time interval that ends after the beginning of the lifespan, or simply a point in time.

There may be several different possible lifespan terminators specified for a particular lifespan, any of which may operate to end the lifespan. Alternatively, a lifespan may continue indefinitely. For each lifespan terminator, an “eventTerminator” element is defined, which may include conditions. The eventTerminator element specifies whether the event instances that are considered during a lifespan are to be discarded from further considerations after the termination of the lifespan or not. In cases involving multiple lifespans, the eventTerminator element establishes an order of lifespan termination. Alternatively, the eventTerminator element may specify that all lifespans terminate simultaneously.

Using a plurality of initiators and terminators allows expressing complex conditions in determining a lifespan for use in a query. In all cases, it is necessary to determine the earliest points in time at which one of the initiators, and one of the terminators are encountered in the event history.

Lifespans may have related keys, which can specify conditions for lifespan initiator, terminator, and eventually for the operands of a related situation, as described below. If a key is introduced into a lifespan, then only event instances that have the same key value can initiate or terminate that lifespan.

A sample lifespan definition is shown in Listing 1. The definition does not involve keys. Rather, it presents a time interval that starts with the first occurrence of an initiating event and ends with the first occurrence of a terminating event or 90 minutes after the start of the lifespan, whichever occurs first.

Listing 1

<lifespan name=“L_90AfterActivity” updateDefinition=“add”>

<initiator>

<eventInitiator name=“CustomerBuy” correlate=“ignore”/>
<eventInitiator

name=“CustomerSell” correlate=“ignore”/>

</initiator>
<terminator>

<eventTerminator name=“CustomerBuyl” quantifier=“first” />
<eventTerminator name=“CustomerSell” quantifier=“first” />
<expirationInterval timeInterval=“5400000” />

</terminator>

</lifespan>

The lifespan is realized as a view using common table expressions, as shown in Listing 2. The first table expression shows the timestamp of the first event occurrence of event types: “CustomerBuy” and “CustomerSell”. This is the start of the lifespan. The second expression defines the timestamp of the first event occurrence of types CustomerBuy or CustomerSell after the beginning of the lifespan. The last expression defines a 90-minute timestamp measured from the start of the lifespan. The end of the lifespan is defined as the minimum of the timestamps denoting “CustomerBuy”, “CustomerSell”, and the 90-minute timestamp.

Listing 2

CREATE VIEW AMT.L_90AfterActivity AS

WITH

T (MinTime) AS

(
SELECT MIN (AMT.V_Event.tempDimension)
FROM AMT.V_Event, AMT.V_CustomerBuy,
AMT.V_CustomerSell
WHERE AMT.V_Event.eventName IN
(‘CustomerBuy’,
‘CustomerSell’)

),

T1 (MaxTime1) AS

(

SELECT MIN (AMT.V_Event.tempDimension)

FROM AMT.V_Event, AMT.V_CustomerBuy,

AMT.V_CustomerSell

WHERE AMT.V_Event.eventName IN
(‘CustomerBuy’,
‘CustomerSell’)
AND AMT.V_Event.tempDimension >
(SELECT MinTime FROM T)

),

T2 (MaxTime2) AS

(

SELECT MinTime + 00000000009000.000000
FROM T

)

SELECT * FROM AMT.V_Event
WHERE tempDimension >= (SELECT MinTime FROM T)
AND tempDimension <= (SELECT MaxTime1 FROM T1)
AND tempDimension <= (SELECT MaxTime2 FROM T2);

-- Duration format:yyyymmddhhmmss.zzzzzz

Lifespan views are created automatically by the event query processor 23 (FIG. 1).

Situations.

Situation definitions are the main constructs in the event specification language. As noted above, a detected situation may instigate predefined actions of the system 20 (FIG. 1). A detected situation is reported as a new event and inserted in the event database 26. This allows the chained or nested execution of one or more situation operators. A “situation” element specifies a unique name of the situation, and the interval during which the situation is valid.

Each situation definition consists of three distinct parts:
1) A header defines the situation identifier (name), and a lifespan during which the situation is valid. It also defines the detection mode over the event instances.
2) A situation operator with additional qualifiers.
3) Composite event data.

The specifics of the event query processor impose a “deferred” detection mode—the detection is done at the end of each lifespan, taking into account all event instances.

A situation data type also includes situation attributes. A situation is defined using “situationAttribute” elements in the situation definition construct to specify event attributes and values, and by “attributeType” elements in the corresponding event definition to specify the data types of corresponding attributes.

Situation Operators.

A situation operator has two components. One of them serves as an additional filter over the lifespan view, and is realized as a situation view, as explained in further detail hereinbelow. It defines conditions on all the participating event instances, and conditions for specific event type. The other component relates to the specifics of the event algebra that is used in the event query processor 23 (FIG. 1). This includes event-oriented algebraic operators, and event types being sought. Additional parameters that specify further conditions for candidate event instances are also referenced. Various event-oriented algebraic operators are supported, and are set forth in further detail in the above-noted U.S. Pat. No. 6,604,093:

In using event-oriented algebraic operators in the event query processor, it is necessary to evaluate event instance selection, and an event instance consumption policy. Accordingly, the first, last, or all candidate event instances can be specified for a particular event type. The event instance consumption policy determines whether event instances that were used to detect a given situation are to persist, or to be discarded.

Event-oriented algebraic operators augment relational and algebraic operators that are available in known query languages. Detected composite events may be announced to external consumers, and can be inserted in the database.

Understanding of composite event detection logic will be facilitated by a discussion of a particular operator that is used in the event query processor. An operator all defines a conjunction of events without a particular order in their occurrence. Each participating event type is defined via an operandAll element. The operator all can be realized using the pseudocode fragments shown in Listing 3. In addition, situation detection using operators can be built as user-defined functions and invoked directly in SQL statements.

Listing 3

| // Check whether situation ALL for N event types exists | | | |
|---|---|---|---|
| - if the number of events equals N, then situation ALL | | | |
| is detected. | | | |
| SELECT COUNT (DISTINCT eventName) AS C | | | |
| FROM S_View | | | |
| WHERE | eventName | IN | (operandAll.eventType1... |

operandAll.eventTypei);
// Find the event instances of each event type with the
lowest timestamps
SELECT * FROM

(SELECT X.*, RANK ( ) OVER
(PARTITION BY name

ORDER BY transactionTime ASC)
AS R1 FROM SituationView X) AS XXX
WHERE R1 = 1
AND eventName IN (operandAll.eventType1...
operandAll.eventTypei)
ORDER BY tempDimension;

The operator all can be realized using only SQL logic. However, other operators have to be realized by supplementing the SQL capabilities with additional facilities. For example, an operator sequence defines particular sequences of events in an event history that may or may not include intermediate events. In order to realize this operator, regular expressions are applied, as shown by the following steps:
(1) Select all events from a subset of events defined by the respective lifespan and situation views, sorted by their timestamps in ascending order.
(2) Transform the selected set into an alphabetic sequence.
(3) Build regular expression for the defined pattern.
(4) Detect patterns in the alphabet sequence.
   Event Query Processor.

Referring again to FIG. 1, a modified event specification language is provided for use by the event query processor 23. The event query processor 23 parses the event definition specifications using the event rule engine 25, builds appropriate logic, for example SQL logic, and queries the event database 26. In case of detected situations, it inserts composite events in the event database 26. Once an event is detected, the system 20 may take appropriate actions. The language provided by Amit is suitable.

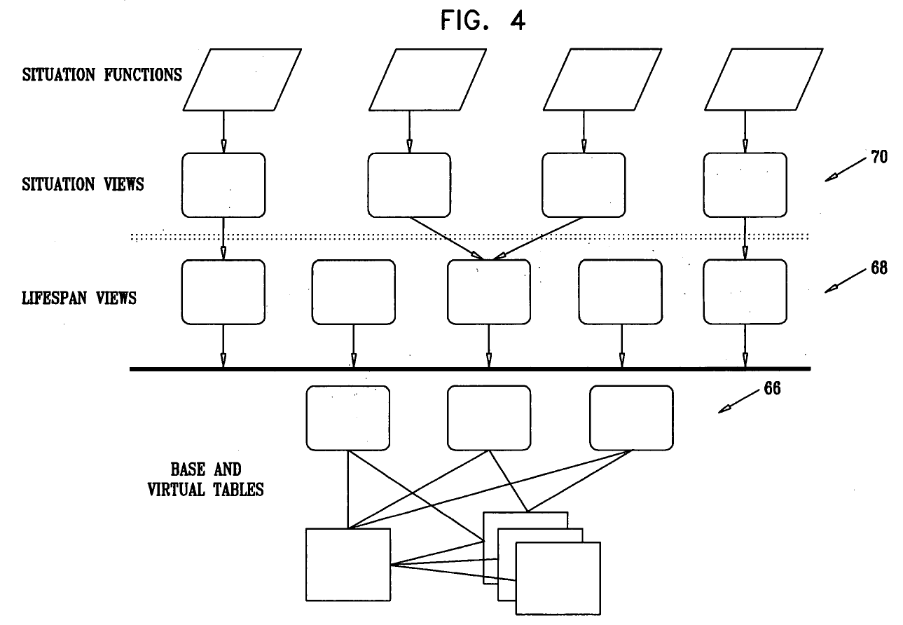

Reference is now made to FIG. 4, which is a block diagram presenting layered information architecture of an event query processor in accordance with a disclosed embodiment of the invention. Each of the layers is independent of the adjacent layers above and below it, which allows for transparent modification and further development. A bottom layer 66 consists of a set of base tables for the root class and the descendent classes, a set of referential integrity constraints over the tables, and a set of views.

A second layer 68, shown above the layer 66, consists of a set of views that present relevant lifespan subsets of the event data. Each lifespan has an initiating and terminating event or time point, thus having starting and ending time points as a time interval. Between the initiating and terminating events, there is a sequence of events that belong to the time interval and are a subset of all the events in the database. These subsets are dynamic and can change with the detection of new events.

A top level 70 contains composite events or situations. The situations are defined as views, realized as select statements in the event query language, over the underlying lifespan views of the layer 68. The situation views are an aspect of complex events that is SQL-oriented. Such view filter the lifespan views and presents further refined subsets of the event instances. Over these subsets are realized situation functions that detect possible composite events. The functions are expressed using an event algebra oriented logic that augments the relational algebraic operations. As noted above, in case of such detection, relevant event instances are inserted in the event database and pre-defined actions are taken.

Query Execution Order.

Defined situations are processed as one or more situation queries over the event database. These queries are executed off-line in the event database 26 (FIG. 1) rather than in real-time or near real-time. It will be recalled that after detecting valid situations, the event query processor inserts composite events into the event database. Depending on the event consumption policies, the event query processor may also drop from further consideration event instances that triggered detection of a situation. Consequently, the order of execution of the situation queries is important for the correct detection of composite events in the event history.

A further consideration is the number of query executions that are necessary to process a set of defined situations. If there are no situations to be detected in the event histories, the number of executions is equal to the number of the defined situations. If there are detected situations, it becomes necessary to re-execute some of the queries. In a brute force approach, all the queries would be re-executed in their temporal order as long as there are new detections. It is possible, however, to reduce the number of query executions using a more elaborate strategy. An algorithm for determining the proper query execution order must satisfy the following conditions: (1) ensure detection of all possible situations over the event history; and (2) minimize the overall number of query executions.

The order of query execution depends on the time order of the temporal intervals over which the situations are defined, and their relationships. It is important to be able to distinguish events that occur at particular time points that are contained within overlapping time intervals in respect of different events. This is necessary in order to relate events and the time intervals during which they occur, and to reason about the various time intervals. It will be recalled that events occur at particular time points, have no duration, and that the time points are linearly ordered. However, time intervals include a set of time points, and have duration. Complex relationships may exist among time intervals. Thus, an event A can happen during a time interval I or outside of it.

The algorithm for query execution ordering consists of ordering the defined lifespans in the order of their starting times, and their ending times. In general, the most deeply nested internal intervals are most highly prioritized for purposes of sorting. Other sort order details may be heuristically varied. In order to reduce the number of query executions, we use the interval relationships between the related lifespans, and form groups based on the relationships. This effectively builds a lifespan graph where the nodes are the defined lifespans and the edges are the interval relationships. Then an execution path is established traversing the graph.

Groups are formed, consisting of all lifespans that have following relationships: (1) I starts J; (2) I during J; (3) I finishes J; (4) 1 equals J. For each group the lifespans are sorted in the following orders:
Group (1) is sorted in ascending order of the end times of its members.
Group (2) is sorted in descending order of the start times and ascending order of the end times of its members.
Group (3) is sorted in descending order of the start times of its members.
In group (4), the order is not important.

For each group, the queries are executed according to the established order. Whenever a situation is detected, a new composite event is inserted in the database; the query groups are re-examined; and for all lifespans that encompass the composite event, the respective queries are re-executed.

Alternatively, it is possible to assign priorities to situations and execute the queries accordingly.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method for situation detection implemented by a computer, comprising the steps of:
storing component events in an event database;
specifying a composite event as a combination of at least first and second instances of said component events;
defining a rule, which causes a reaction to be invoked upon detection of said composite event in said event database, wherein said rule comprises at least one algebraic event-oriented operator;
defining a query comprising said rule for said component events;
executing said query to search said event database and
applying said rule in said event database to determine whether said first and second instances of said component events can satisfy said rule, by the steps of:
responsively to applying said rule, determining that said composite event has occurred; and
invoking said reaction.

2. The method according to claim 1, wherein said rule further comprises a specification of a lifespan of at least one of said component events.

3. The method according to claim 1, wherein said rule further references a plurality of lifespans, further comprising the steps of:
ordering said lifespans in accordance with a predetermined sorting criterion;
defining a lifespan graph having nodes comprising said lifespans and having edges comprising interval relationships among said lifespans;
defining at least one new query; and
executing said query and said new query in an execution order that is defined by an execution path formed by a traversal of said graph.

4. The method according to claim 3, wherein said sorting criterion is starting points of said lifespans.

5. The method according to claim 3, wherein said sorting criterion is ending points of said lifespans.

6. The method according to claim 1, wherein applying said rule comprises implementing an event consumption policy.

7. The method according to claim 1, wherein said reaction comprises modifying said event database.

8. The method according to claim 1, wherein one of said component events is a primitive event.

9. The method according to claim 1, wherein one of said component events is a constituent composite event.

10. A computer software product, including a computer-readable medium in which computer program instructions are stored, which instructions, when read by a computer, cause the computer to perform an automated method for situation detection, comprising the steps of:
storing component events in an event database;
specifying a composite event as a combination of at least first and second instances of said component events;
defining a rule, which causes a reaction to be invoked upon detection of said composite event in said event database, wherein said rule comprises at least one algebraic event-oriented operator;
defining a query comprising said rule for said component events;
executing said query to search said event database and
applying said rule in said event database to determine whether said first and second instances of said component events can satisfy said rule, by the steps of:
responsively to applying said rule, determining that said composite event has occurred; and
invoking said reaction.

11. The computer software product according to claim 10, wherein said rule further comprises a specification of a lifespan of at least one of said component events.

12. The computer software product according to claim 10, wherein said rule further references a plurality of lifespans, further comprising the steps of:
ordering said lifespans in accordance with a predetermined sorting criterion;
defining a lifespan graph having nodes comprising said lifespans and having edges comprising interval relationships among said lifespans;
defining at least one new query; and
executing said query and said new query in an execution order that is determined by an execution path formed by a traversal of said graph.

13. The computer software product according to claim 12, wherein said sorting criterion is starting points of said lifespans.

14. The computer software product according to claim 12, wherein said sorting criterion is ending points of said lifespans.

15. The computer software product according to claim 10, wherein applying said rule comprises implementing an event consumption policy.

16. The computer software product according to claim 10, wherein said reaction comprises modifying said event database.

17. The computer software product according to claim 10, wherein one of said component events is a primitive event.

18. The computer software product according to claim 10, wherein one of said component events is a constituent composite event.

19. A data processing system for situation detection, comprising:
a processor operative for storing component events in an event database;
an event query processor executing in said processor that is operative to perform the steps of specifying a composite event as a combination of at least first and second instances of said component events;
accepting as an input a rule, which causes a reaction to be invoked upon detection of said composite event in said event database, wherein said rule comprises at least one algebraic event-oriented operator;
constructing a query comprising said rule for said component events;
executing said query to search said event database and
applying said rule in said event database to determine whether said first and second instances of said component events can satisfy said rule, by the steps of:
responsively to applying said rule, determining that said composite event has occurred said processor is operative for invoking said reaction.

20. The data processing system according to claim 19, wherein said rule further comprises a specification of a lifespan of at least one of said component events.

21. The data processing system according to claim 19, wherein said rule further references a plurality of lifespans, and said event query processor is further operative to perform the steps of:
ordering said lifespans in accordance with a predetermined sorting criterion;
defining a lifespan graph having nodes comprising said lifespans and having edges comprising interval relationships among said lifespans;
defining at least one new query; and
executing said query and said new query in an execution order that is determined by an execution path formed by a traversal of said graph.

22. The data processing system according to claim 21, wherein said sorting criterion is starting points of said lifespans.

23. The data processing system according to claim 21, wherein said sorting criterion is ending points of said lifespans.

24. The data processing system according to claim 19, wherein applying said rule comprises implementing an event consumption policy.

25. The data processing system according to claim 19, wherein said reaction comprises modifying said event database.

26. The data processing system according to claim 19, wherein one of said component events is a primitive event.

27. The data processing system according to claim 19, wherein one of said component events is a constituent composite event.
